(19) United States
(12) Patent Application Publication
(10) Pub. No.: US 2023/0390661 A1
(43) Pub. Date: Dec. 7, 2023

(54) LIGHTSABER BLADE

(71) Applicant: Joel Pinkham, Springfield, OR (US)

(72) Inventor: Joel Pinkham, Springfield, OR (US)

(21) Appl. No.: 18/236,550

(22) Filed: Aug. 22, 2023

(51) Int. Cl. A63H 33/00; F21V 33/00; A63H 33/22

(52) U.S. Cl. CPC A63H 33/009; F21V 33/008; A63H 33/22

(57) ABSTRACT

The present disclosure relates to a lightsaber blade. The lightsaber blade includes a first end and a second end disposed on the opposite side. A translucent intermediate portion is arranged between the first end and the second end of the lightsaber blade. A first connection element is disposed on the first end and a second connection element is disposed on the second end. Embodiments of the present invention further disclose various types of modular lightsabers constructed using the lightsaber blade. The new and improved lightsaber blade has the advantage that both ends of the lightsaber blade could be used for removably connecting the lightsaber blade to a variety of accessories and devices.

### TECHNICAL FIELD

The present invention relates to the field of toy swords and lightsabers.

### BACKGROUND

Toy swords are commercially available to delight people, in particular children, in fictitious swordplay. By mimicking the actual sword fighting of knights, such toys allow children to practice the thrusts and parties of actual duels while having safety in practicing it. Such toys can be based on conventional swords having a hilt or handle from which a long blade extends.

Certain movies have also generated interest in not just conventional swords but lightsabers. For example, the Star Wars® movies have generated extreme interest in this matter. Typically, lightsabers comprise a handle or hilt and a laser tube or a lightsaber blade extending from the handle or hilt.

Further, modular lightsabers exist in the prior art that allows people to build their own customized lightsaber by selecting parts according to their choice. These modular lightsabers comprise a handle or hilt as well as one or more laser tubes or lightsaber blades wherein the handle or hilt could be removably connected to any one of the lightsaber blades using a variety of ways such as but not limited to twist couplings, luer locks, snap-fit couplings and so on. Generally, a conventional lightsaber blade is elongated and cylindrical in nature. Further, the conventional lightsaber blade has a first open end to receive the handle, wherein the opposite second end of the lightsaber blade is closed (sealed).

An example of such lightsaber blades is disclosed in U.S. Pat. No. 9,579,587B1 titled “Inflatable toys having interchangeable parts”. The FIG. 1 of U.S. Pat. No. 9,579,587B1 illustrates an inflatable toy sword 20 includes an inflatable blade 22 having a proximal end 24 and a distal end 26. In one embodiment, the distal end 26 and the long sides of the inflatable blade 22 are sealed. Another example of such lightsaber blades is disclosed in U.S. Pat. No. 5,947,789A titled “Toy sword having a variable color illuminated blade”.

The conventional lightsaber blade is suited for use for a single purpose as the conventional lightsaber blade can be connected to the handle by using the open end of the conventional lightsaber blade. The present invention seeks to improve upon the conventional lightsaber blade by providing a new and improved lightsaber blade that is open at both ends (sides). The new and improved lightsaber blade has the advantage that both ends of the lightsaber blade could be used for removably connecting the lightsaber blade to a variety of accessories and devices as will described in the description to follow.

### SUMMARY

While the way that the present disclosure addresses the disadvantages of the prior art will be discussed in greater detail below, in general, the present disclosure provides a lightsaber blade comprising: a first end and a second end disposed on the opposite side; a translucent intermediate portion arranged between the first end and the second end, wherein the translucent intermediate portion is configured to allow light to pass therethrough; a first connection element disposed on the first end; a second connection element disposed on the second end; wherein the first connection element and the second connection element comprise a plurality of screw threads and a plurality of screw threads respectively.

In an embodiment, the plurality of screw threads of the first connection element are disposed on the external surface of the first end.

In an embodiment, the plurality of screw threads of the second connection element are disposed on the internal surface of the second end.

In an embodiment, the first connection element is configured for a removable threaded connection with a light source.

In an embodiment, the connection element is configured for a removable threaded connection with an object selected from a group comprising of a light source, an accessory, an end plug, an inverse coupler, a sparkler coupler, a male coupler and a female coupler.

In an embodiment, the second connection element is configured for a removable threaded connection with an additional lightsaber blade to form a dual lightsaber blade, wherein the overall length of the dual lightsaber blade is equal to the sum of the lightsaber blade and the additional lightsaber blade.

In an embodiment, the lightsaber blade is substantially formed of a material comprising polycarbonate, glass, plastics, and combinations thereof.

Embodiments of the present invention further discloses a modular lightsaber comprising: a plurality of light sources and a plurality of lightsaber blades arranged in a linear pattern; wherein each light source comprises a light emitting end and an opposite second end; wherein each lightsaber blade comprises a first end and a second end disposed on the opposite side; a translucent intermediate portion arranged between the first end and the second end; a first connection element disposed on the first end; a second connection element disposed on the second end; wherein the first connection element of each lightsaber blade is removably connected to the light emitting end of a corresponding distinct light source selected from the plurality of light sources; at least one inverse coupler, wherein each inverse coupler is configured to facilitate removable coupling between the second connection element of a lightsaber blade and the second end of a corresponding distinct light source selected from the plurality of light sources.

In an embodiment, the inverse coupler comprises a ring-like cylindrical portion, a finger actuation portion disposed over the cylindrical portion, and a pair of screw couplings arranged on the opposite sides of the finger actuation portion.

In an embodiment, the light source comprises a handle portion, at least one actuation switch, a light emitting mechanism, and a battery.

In an embodiment, the first connection element and the second connection element comprise a plurality of screw threads and a plurality of screw threads respectively.

In an embodiment, the plurality of screw threads of the first connection element are disposed on the external surface of the first end.

In an embodiment, the plurality of screw threads of the second connection element is disposed on the internal surface of the second end.

Embodiments of the present invention further discloses a modular lightsaber comprising: a pair of light sources and a lightsaber blade; wherein each light source comprises a light emitting end and an opposite second end; wherein the lightsaber blade comprises a first end and a second end disposed on the opposite side; a translucent intermediate portion arranged between the first end and the second end; a first connection element disposed on the first end; a second connection element disposed on the second end; wherein the light emitting end of a light source selected from the pair of light sources is removably connected to the first connection element of the lightsaber blade; wherein the light emitting end of the remaining light source selected from the pair of light sources is removably connected to the second connection element of the lightsaber blade; an inverse coupler configured to facilitate removable coupling between the second connection element of a lightsaber blade and the light emitting end of the remaining light source selected from the pair of light sources.

In an embodiment, the inverse coupler comprises a ring-like cylindrical portion, a finger actuation portion disposed over the cylindrical portion, and a pair of screw couplings arranged on the opposite sides of the finger actuation portion.

In an embodiment, the light source comprises a handle portion, at least one actuation switch, a light emitting mechanism, and a battery.

In an embodiment, the first connection element and the second connection element comprise a plurality of screw threads and a plurality of screw threads respectively.

In an embodiment, the plurality of screw threads of the first connection element are disposed on the external surface of the first end.

In an embodiment, the plurality of screw threads of the second connection element are disposed on the internal surface of the second end.

### BRIEF DESCRIPTION OF THE DRAWINGS

A more complete understanding of the present disclosure may be derived by referring to the detailed description and claims when considered in connection with the figures, wherein like reference numerals refer to similar elements throughout the figures, and

FIG. 1 illustrates a front view of a lightsaber blade, according to an embodiment of the present invention.

FIG. 2 illustrates a right-hand side view of the lightsaber blade of FIG. 1, according to an embodiment of the present invention.

FIGS. 3-5 illustrates a top view, a side view, and a bottom view of an end plug respectively, according to an embodiment of the present invention.

FIG. 6 illustrates a front view of a modular lightsaber wherein the modular lightsaber comprises a single lightsaber blade coupled to a pair of light sources at both opposite ends.

FIG. 7 illustrates a front view of a modular lightsaber, wherein the modular lightsaber comprises a plurality of light sources and a plurality of lightsaber blades arranged in a linear pattern, according to another embodiment of the present invention.

FIGS. 8-10 illustrates a front view, a front perspective view and a side view of an inverse coupler respectively, according to an embodiment of the present invention.

FIGS. 11-13 illustrates a side view, a top perspective view, and a top view of a sparkler coupler respectively, according to an embodiment of the present invention.

FIGS. 14-16 illustrates various views of the sparkler coupled to the lightsaber blade by using the sparkler coupler of FIGS. 11-13.

FIGS. 17-18 illustrates various accessories coupled to the lightsaber blade, according to various embodiments of the present invention.

FIGS. 19-21 illustrates a front view, a front perspective view, and a side view of a male coupler respectively, according to an embodiment of the present invention.

FIGS. 22-23 illustrates a front perspective view and a side view of a female coupler respectively, according to an embodiment of the present invention.

### DETAILED DESCRIPTION

The following description is of exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not for limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

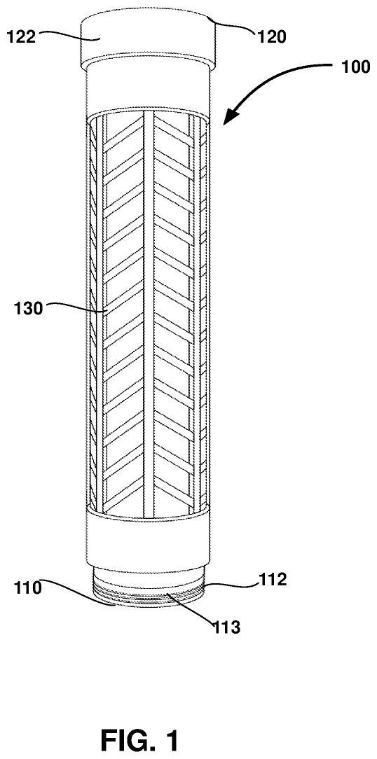

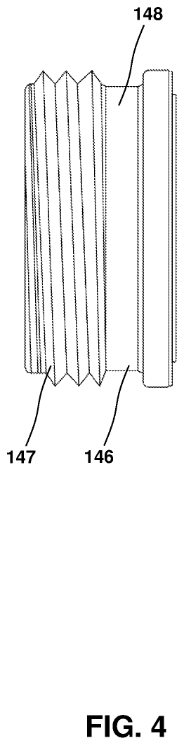

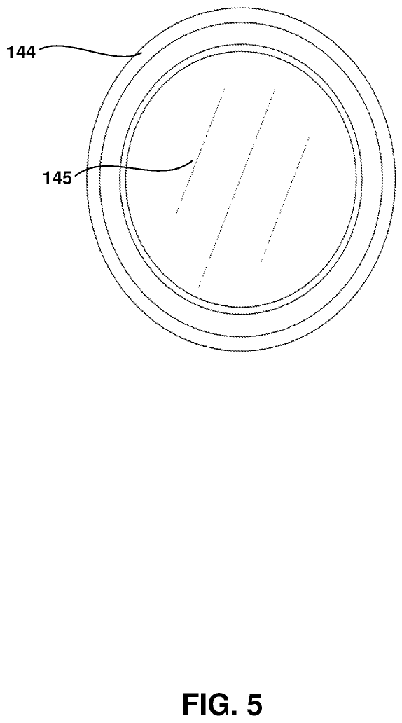

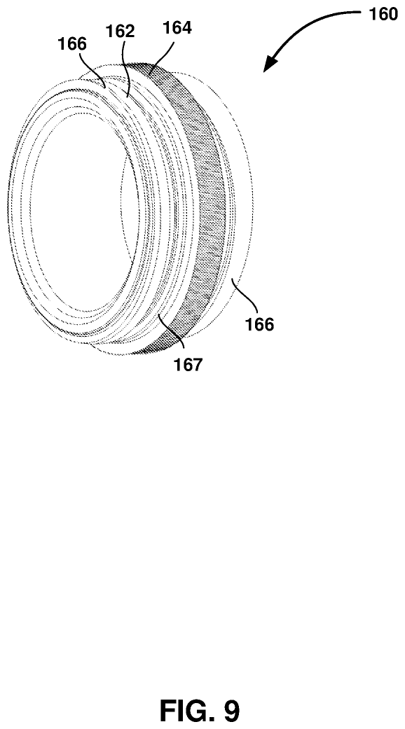

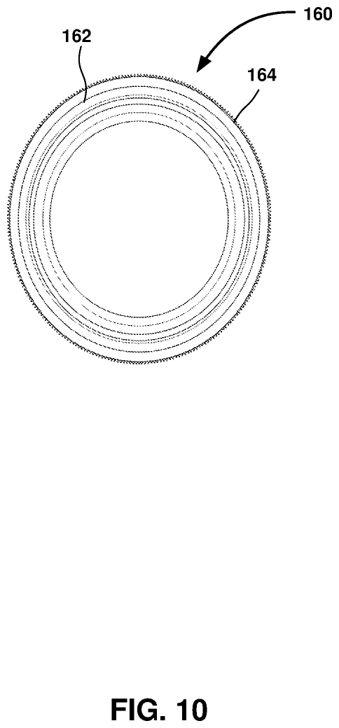

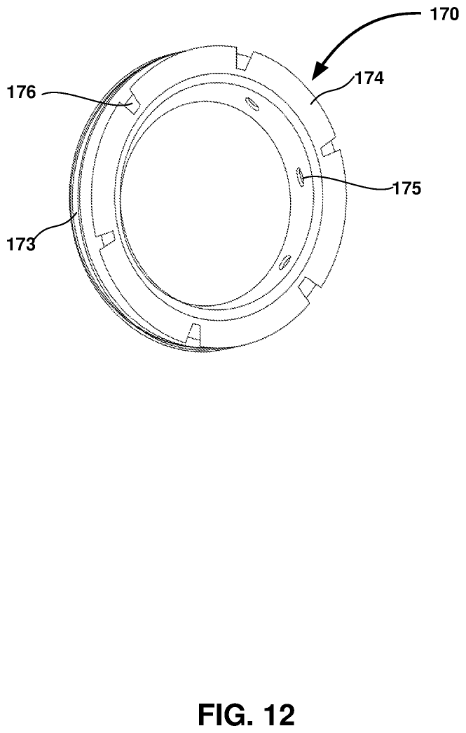

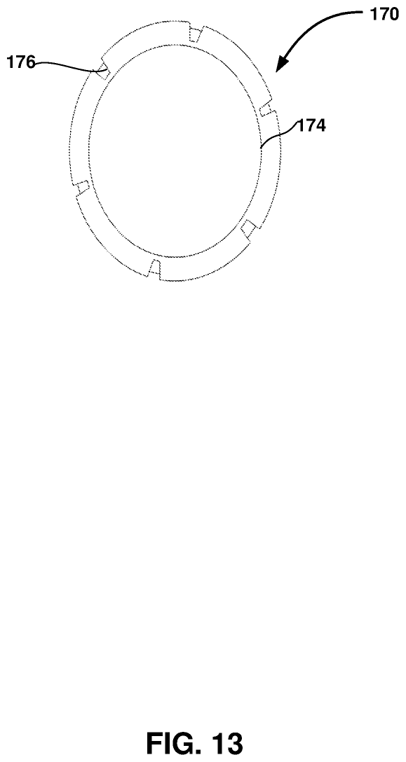

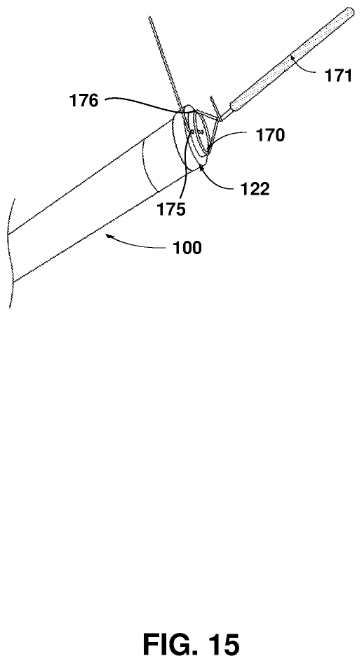

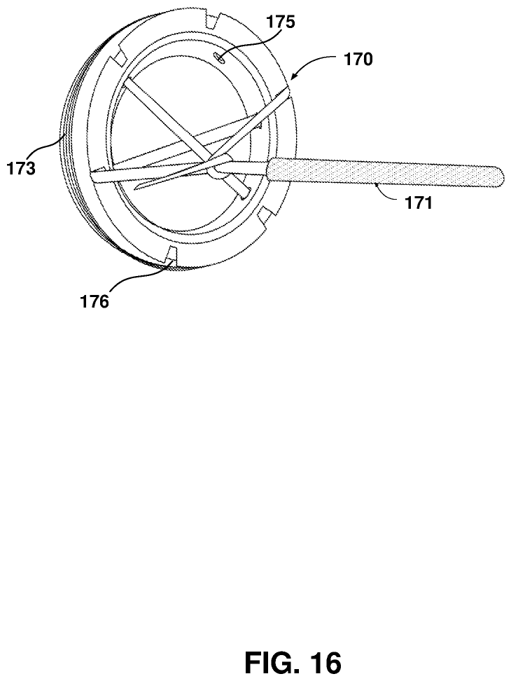

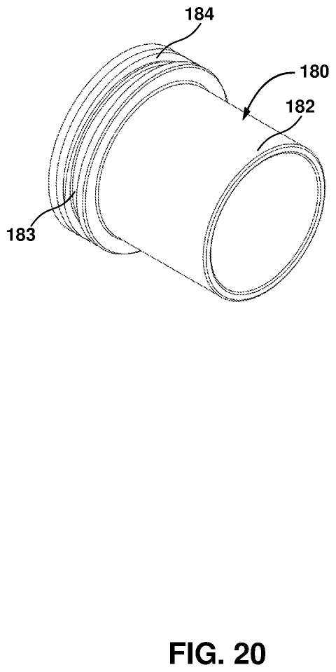

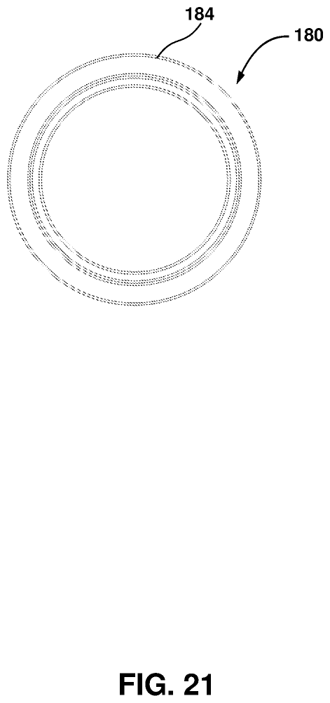

The lightsaber blade and method of using the lightsaber blade will now be described with reference to the accompanying drawings, particularly FIGS. 1-23.

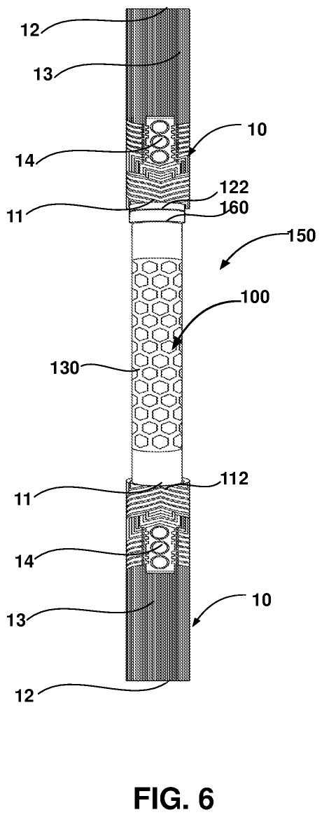

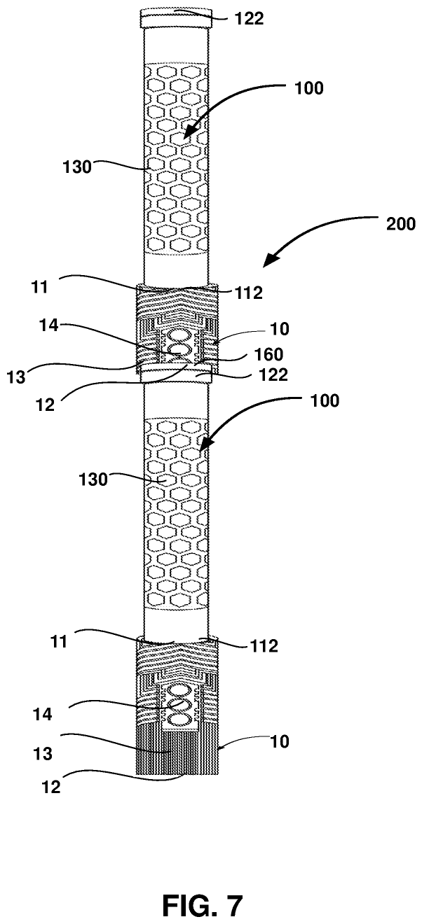

Reference is initially made to FIG. 1 which illustrates a front view of a lightsaber blade 100, according to an embodiment of the present invention. The lightsaber blade 100 is substantially cylindrical in shape and comprises a first end 110 and a second end 120 disposed on the opposite side of the first end 110. A translucent intermediate portion 130 is arranged between the first end 110 and the second end 120, wherein the translucent intermediate portion 130 is configured to allow light to pass therethrough such that the translucent intermediate portion 130 is configured to glow and emit light in surroundings. In an embodiment, the translucent intermediate portion 130 is configured to transmit light coming from a light source 10 (FIG. 6). In an embodiment, the lightsaber blade 100 is substantially formed of a material comprising of polycarbonate, glass, plastics and/or combinations thereof. Further, the translucent intermediate portion 130 could have various geometrical design features (imprinted patterns) including but not limited to: parallel parallelogram design (butterfly design) as seen in FIG. 1, honeycomb design as seen in FIG. 6 and FIG. 7, triangle design (not shown in figures), square design (not shown in figures) and so on.

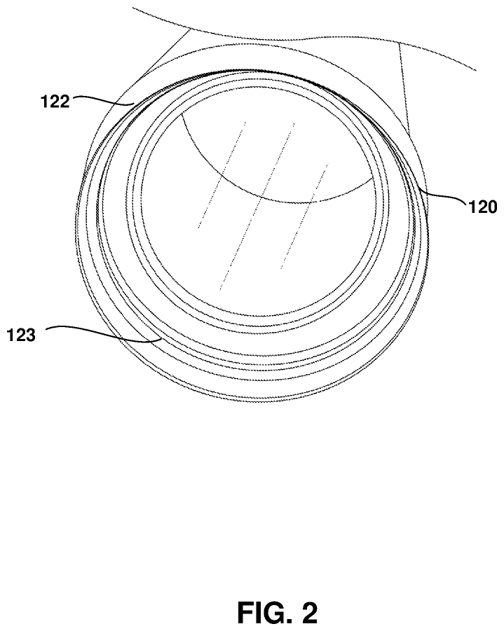

A first connection element 112 is disposed on the first end 110 and a second connection element 122 is disposed on the second end 120. In an embodiment, the first connection element 112 and the second connection element 122 comprises a plurality of screw threads 113 and a plurality of screw threads 123 (FIG. 2) respectively. In other embodiments (not shown in figures), the first connection element 112 and the second connection element 122 comprise at least one of luer locks, pins, bolts, magnets, snap-fit couplings, flange couplings, friction couplings, keyways, and so on.

In an embodiment as seen in FIG. 1, the plurality of screw threads 113 of the first connection element 112 are disposed on the external surface of the first end 110. Further, the plurality of screw threads 123 of the second connection element 122 are disposed on the internal surface of the second end 120 as seen in FIG. 2.

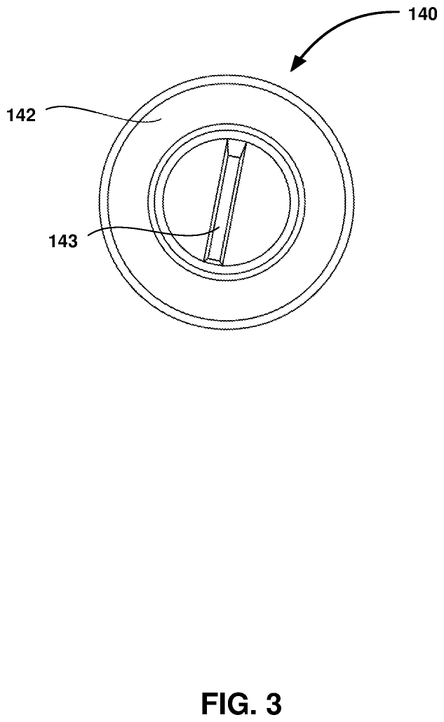

Referring to FIGS. 3-5 that illustrates a top view, a side view, and a bottom view of an end plug 140 respectively, according to an embodiment of the present invention. The end plug 140 is configured to seal (close) the second end 120 of the lightsaber blade 100 of FIG. 1. A top surface 142 of the end plug 140 includes a raised protrusion 143 that is configured to be manually grasped by the finger and thumb of the user to facilitate the connection between the end plug 140 and the second end 120 of the lightsaber blade 100 of FIG. 1. A bottom surface 144 of the end plug 140 includes a mirror 145 to reflect light backward towards the lightsaber blade 100. Further, a side surface 146 of the end plug 140 includes a plurality of screw threads 147 to enable the connection between the end plug 140 and the second end 120 of the lightsaber blade 100. Further, a sealing ring passage 148 is arranged on the side surface 146 to receive a sealing ring (not shown in figures) such as an O ring. The sealing ring (not shown in the figures) ensures mechanical tightness of the connection between the end plug 140 and the second end 120 of the lightsaber blade 100.

By sealing the second end 120 of the lightsaber blade 100 by using the end plug 140, the lightsaber blade 100 could effectively function in a conventional manner. In other words, the first end 110 of the lightsaber blade 100 could be removably connected to a light source 10 (FIG. 6), and the second end 120 of the lightsaber blade 100 is effectively sealed (closed) by using the end plug 140, thereby mimicking a conventional lightsaber blade (not shown in figures) with one open end and one closed end.

FIG. 6 illustrates a front view of a modular lightsaber 150 wherein the modular lightsaber 150 comprises a single lightsaber blade 100 coupled to a pair of light sources 10 at both ends. Both light sources 10 are identical and conventional in nature and sold by various merchandise using various product names such as but not limited to: RGB Critter® 2.0. In an embodiment, the light source 10 is essentially a color-changing flashlight (torch). Each light source 10 comprises a light-emitting end 11 and an opposite second end 12. The light source 10 comprises a handle portion 13, at least one actuation switch 14 to control various operational parameters such as brightness control and strobe speed as well as adjusting preset pattern speeds, sound reactivity, and movement reactivity. Further, the light source 10 comprises a light emitting mechanism 15 (not shown in figures) such as but not limited to: LED (light emitting diode), bulb, plasma, and so on, and an electric battery 16 to act as the power source.

In another embodiment (not shown in figures), the light source 10 comprises a handle portion 13, and a controller (not shown in figures) to control various operational parameters such as brightness control and strobe speed as well as adjusting preset pattern speeds, sound reactivity, and movement reactivity. The controller (not shown in figures) could include various algorithms/software and the controller (not shown in figures) could take inputs from a remote device such as but not limited to: mobile phone, computer, smartwatch and so on.

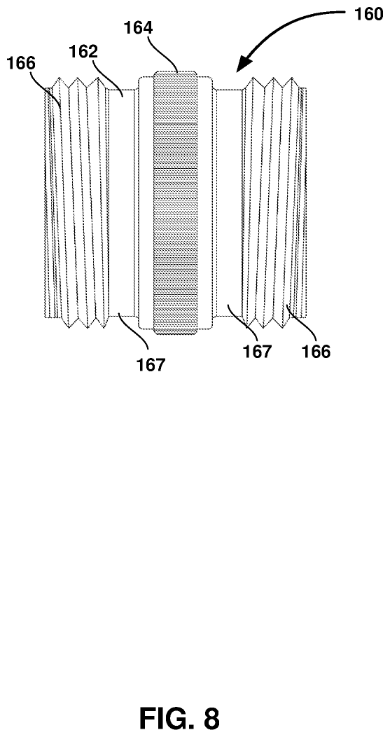

As seen in FIG. 6, the first connection element 112 is configured for a removable threaded connection with a light-emitting end 11 of a light source 10. The light emitting end 11 of the remaining light source 10 selected from the pair of light sources 10 is removably connected to the second connection element 122 of the lightsaber blade 100. Further, the inverse coupler 160 (FIGS. 8-10) is configured to facilitate removable coupling between the second connection element 122 of a lightsaber blade 100 and the light emitting end 11 of the remaining light source 10. It should be understood that the inverse coupler 160 is shown visible in FIG. 6. However, the inverse coupler 160 is at least partially concealed beneath the second connection element 122 of a lightsaber blade 100 and the light emitting end 11 of a distinct light source 10.

In another embodiment (not shown in figures), the second connection element 122 is configured for a removable threaded connection with an additional lightsaber blade 100 to form a dual lightsaber blade (not shown in figures), wherein the overall length of the dual lightsaber blade is equal to the sum of the lightsaber blade 100 and the additional lightsaber blade 100. The dual lightsaber blade (not shown in figures) provides the added advantage that the user can combine multiple lightsaber blades 100 by connecting them to provide a longer lightsaber (not shown in figures).

Referring to FIGS. 7-10, a modular lightsaber 200 will be described in detail. The modular lightsaber 200 comprises a plurality of light sources 10 (earlier described in reference to FIG. 6), and a plurality of lightsaber blades 100 (FIG. 1) arranged in a linear pattern.

As seen in FIG. 7, the first connection element 112 of each lightsaber blade 100 is removably connected to the light emitting end 11 of a corresponding distinct light source 10 selected from the plurality of light sources 10. The second connection element 122 of at least one lightsaber blade 100 is removably connected to the second end 12 of a corresponding distinct light source 10 selected from the plurality of light sources 10 by using at least one inverse coupler 160 (FIGS. 8-10). Each inverse coupler 160 is configured to facilitate removable coupling between the second connection element 122 of a lightsaber blade 100 and the second end 12 of a corresponding distinct light source 10 selected from the plurality of light sources 10. It should be understood that the inverse coupler 160 is shown visible in FIG. 7. However, the inverse coupler 160 is at least partially concealed beneath the second connection element 122 of a lightsaber blade 100 and the second end 12 of a corresponding distinct light source 10.

Referring to FIGS. 8-10, the inverse coupler 160 is described in detail. The inverse coupler 160 comprises a ring-like cylindrical portion 162, a finger actuation portion 164 disposed over the cylindrical portion 162, and a pair of screw couplings 166 arranged on the opposite sides of the finger actuation portion 164. The finger actuation portion 164 is configured to be manually grasped by the hands of the user to rotate the inverse coupler 160. Further, a pair of sealing ring passages 167 are arranged on the opposite sides of the finger actuation portion 164 to receive sealing rings (not shown in figures) such as O rings. The sealing rings (not shown in figures) ensures mechanical tightness of the connection between the inverse coupler 160, the second connection element 122 of a lightsaber blade 100, and the second end 12 of a corresponding distinct light source 10 selected from the plurality of light sources 10.

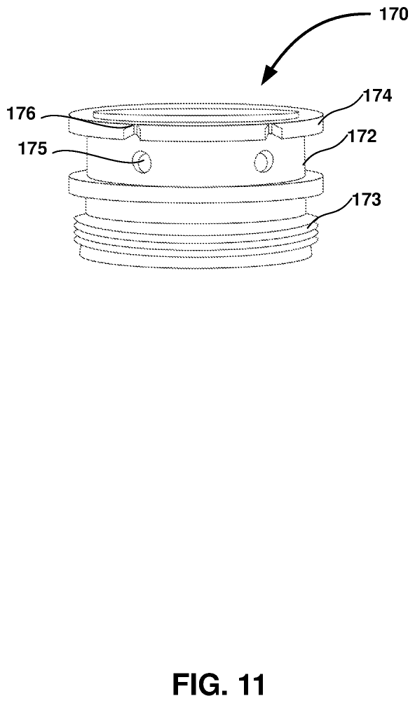

FIGS. 11-13 illustrates a side view, a top perspective view, and a top view of a sparkler coupler 170 respectively, according to an embodiment of the present invention. The sparkler coupler 170 is cylindrical shaped in nature and comprises a cylindrical wall 172. The cylindrical wall 172 comprises a plurality of screw threads 173 on a first end, a flanged portion 174 on an opposite second end, and a plurality of holes 175 in an intermediate portion positioned between the first end and the opposite second end. The flanged portion 174 includes a plurality of cutouts 176 that are V-shaped in nature and are distributed uniformly along the circumference of the flanged portion 174.

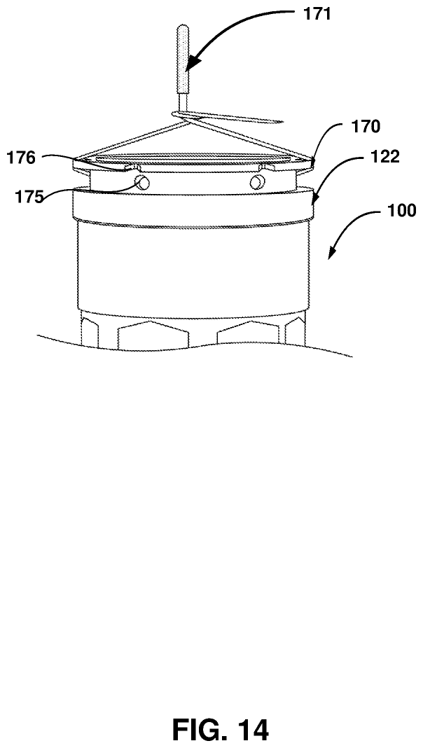

FIGS. 14-16 illustrates various views of sparkler 171 coupled to the lightsaber blade 100 by using the sparkler coupler 170 of FIGS. 11-13. The plurality of screw threads 173 of the sparkler coupler 170 are removably connected to the second connection element 122 of a lightsaber blade 100. As seen in FIGS. 11-13, the wire portion of the sparkler 171 is passed through the plurality of holes 175 and then, bent in shape afterward to prevent accidental release of the sparkler 171 from the sparkler coupler 170. Further, the wire portion of the sparkler 171 is passed through a cutout 176 selected from the plurality of cutouts 176. Afterward, the user can light (fire) the sparkler 171 using firing means (not shown in figures) such as but not limited to a matchstick, lighter, and so on to burn the sparkler 171 arranged in the sparkler coupler 170.

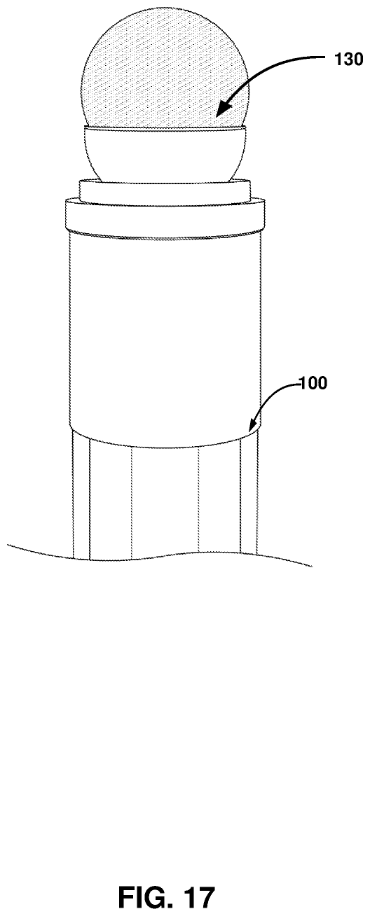

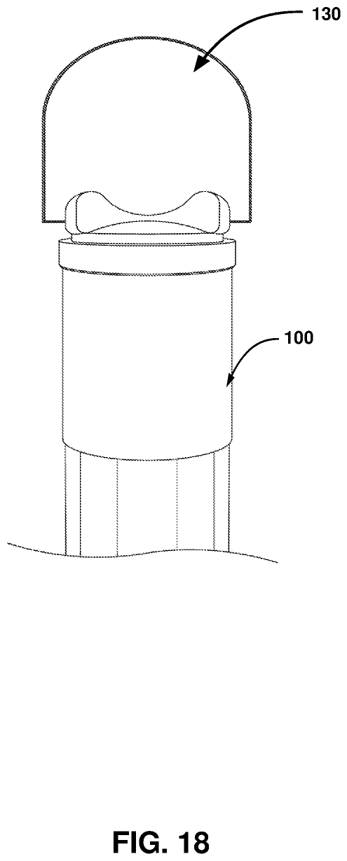

FIGS. 17-18 illustrates various accessories 130 coupled to the lightsaber blade 100, according to various embodiments of the present invention. As seen in FIGS. 17-18, the accessories 130 include a bulb-shaped accessory 130 and a wave (wing) shaped accessory 130 respectively. In various other embodiments (not shown in figures), accessories 130 could have any other shape, design, and size including but not limited to star-shaped accessories, ring-shaped accessories, and so on. It should be understood that the accessories 130 could be removably connected with the first connection element 112 and/or the second connection element 122. In an embodiment, the accessories 130 could have an integral (built-in) connection element (not shown in figures) to removably connect with the first connection element 112 and/or the second connection element 122. In another embodiment, the accessories 130 could be removably connected with the first connection element 112 and/or the second connection element 122. using at least one of: a male coupler 180 and/or a female coupler 190 described below in detail.

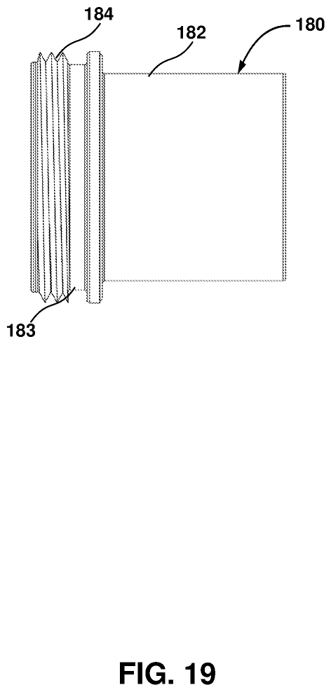

FIGS. 19-21 illustrates a front view, a front perspective view, and a side view of a male coupler 180 respectively, according to an embodiment of the present invention. The male coupler 180 includes a cylindrical wall 182 and a plurality of screw threads 184 arranged on the external surface of the cylindrical wall 182 to enable removable connection with the lightsaber blade 100. Further, a sealing ring passage 183 is arranged on the cylindrical wall 182 to receive a sealing ring (not shown in figures) such as an O ring.

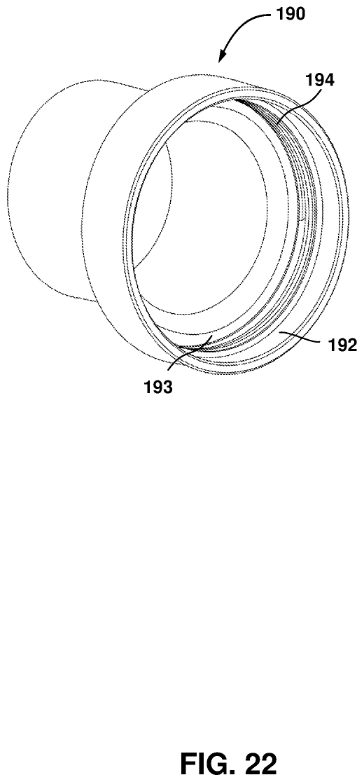

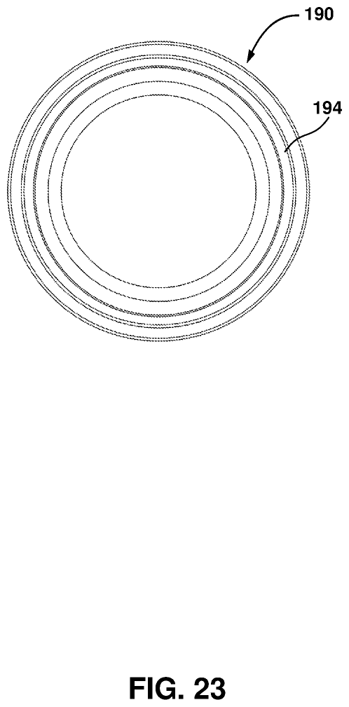

FIGS. 22-23 illustrates a front perspective view, and a side view of a female coupler 190 respectively, according to an embodiment of the present invention. The female coupler 190 includes a cylindrical wall 192 and a plurality of screw threads 194 arranged on the external surface of the cylindrical wall 192 to enable removable connection with the lightsaber blade 100. Further, a sealing ring passage 193 is arranged on the cylindrical wall 192 to receive a sealing ring (not shown in figures) such as an O ring.

The connection element 122 is configured for removable threaded connection with an object selected from a group comprising of: a light source 10, an additional lightsaber blade 100, an accessory 130, an end plug 140, an inverse coupler 160, a sparkler coupler 170, a male coupler 180 and a female coupler 190 as described earlier. Further, it should be well understood that the first connection element 112 and the second connection element 122 are interchangeable in terms of functionality. For instance, in an embodiment (not shown in figures), the first connection element 112 is configured for removable threaded connection with an object selected from a group comprising of a light source 10, an additional lightsaber blade 100, an accessory 130, an end plug 140, an inverse coupler 160, a sparkler coupler 170, a male coupler 180 and a female coupler 190. Broadly speaking, the various components, and parts of the various embodiments of the lightsaber blade 100 of the present invention are similar and interchangeable.

The lightsaber blade 100 according to various embodiments of the present invention is useful in many applications such as but not limited to: Star Wars® duels, Light painting photography, flow arts, light glow sticks, aesthetic effects, decoration, and so on.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A lightsaber blade (100) comprising:
a first end (110), and a second end (120) disposed on the opposite side;
a translucent intermediate portion (130) arranged between the first end (110) and the second end (120), wherein the translucent intermediate portion (130) is configured to allow light to pass therethrough;
a first connection element (112) disposed on the first end (110);
a second connection element (122) disposed on the second end (120); and
wherein the first connection element (112) and the second connection element (122) comprise a plurality of screw threads (113) and a plurality of screw threads (123) respectively.

2. The lightsaber blade (100) according to claim 1, wherein the plurality of screw threads (113) of the first connection element (112) are disposed on the external surface of the first end (110).

3. The lightsaber blade (100) according to claim 1, wherein the plurality of screw threads (123) of the second connection element (122) are disposed on the internal surface of the second end (120).

4. The lightsaber blade (100) according to claim 1, wherein the first connection element (112) is configured for a removable threaded connection with a light source (10).

5. The lightsaber blade (100) according to claim 1, wherein the connection element (122) is configured for removable threaded connection with an object selected from a group comprising of a light source (10), an accessory (130), an end plug (140), an inverse coupler (160), a sparkler coupler (170), a male coupler (180), and a female coupler (190).

6. The lightsaber blade (100) according to claim 1, wherein the second connection element (122) is configured for a removable threaded connection with an additional lightsaber blade (100) to form a dual lightsaber blade, wherein the overall length of the dual lightsaber blade is equal to the sum of the lightsaber blade (100) and the additional lightsaber blade (100).

7. The lightsaber blade (100) according to claim 1, wherein the lightsaber blade (100) is substantially formed of a material comprising of polycarbonate, glass, plastics, and combinations thereof.

8. A modular lightsaber (200) comprising:
a plurality of light sources (10) and a plurality of lightsaber blades (100) arranged in a linear pattern;
wherein each light source (10) comprises a light emitting end (11) and an opposite second end (12);
wherein each lightsaber blade (100) comprises a first end (110) and a second end (120) disposed on the opposite side;
a translucent intermediate portion (130) arranged between the first end (110) and the second end (120);
a first connection element (112) disposed on the first end (110);
a second connection element (122) disposed on the second end (120);
wherein the first connection element (112) of each lightsaber blade (100) is removably connected to the light emitting end (11) of a corresponding distinct light source (10) selected from the plurality of light sources (10); and
wherein the second connection element (122) of at least one lightsaber blade (100) is removably connected to the second end (12) of a corresponding distinct light source (10) selected from the plurality of light sources (10).

9. The modular lightsaber (200) according to claim 8 further comprising at least one inverse coupler (160), wherein each inverse coupler (160) is configured to facilitate removable coupling between the second connection element (122) of a lightsaber blade (100) and the second end (12) of a corresponding distinct light source (10) selected from the plurality of light sources (10); wherein the inverse coupler (160) further comprises a ring-like cylindrical portion (162), a finger actuation portion (164) disposed over the cylindrical portion (162), and a pair of screw couplings (166) arranged on the opposite sides of the finger actuation portion (164).

10. The modular lightsaber (200) according to claim 8, wherein the light source (10) comprises a handle portion (13), at least one actuation switch (14), a light emitting mechanism (15), and a battery (16).

11. The modular lightsaber (200) according to claim 8, wherein the first connection element (112) and the second connection element (122) comprise a plurality of screw threads (113) and a plurality of screw threads (123) respectively.

12. The modular lightsaber (200) according to claim 8, wherein the plurality of screw threads (113) of the first connection element (112) are disposed on the external surface of the first end (110).

13. The modular lightsaber (200) according to claim 8, wherein the plurality of screw threads (123) of the second connection element (122) are disposed on the internal surface of the second end (120).

14. A modular lightsaber (150) comprising:
a pair of light sources (10) and a lightsaber blade (100);
wherein each light source (10) comprises a light emitting end (11) and an opposite second end (12);
wherein the lightsaber blade (100) comprises a first end (110) and a second end (120) disposed on the opposite side;
a translucent intermediate portion (130) arranged between the first end (110) and the second end (120);
a first connection element (112) disposed on the first end (110);
a second connection element (122) disposed on the second end (120);
wherein the light emitting end (11) of a light source (10) selected from the pair of light sources (10) is removably connected to the first connection element (112) of the lightsaber blade (100); and
wherein the light emitting end (11) of the remaining light source (10) selected from the pair of light sources (10) is removably connected to the second connection element (122) of the lightsaber blade (100).

15. The modular lightsaber (150) according to claim 14, wherein an inverse coupler (160) is configured to facilitate removable coupling between the second connection element (122) of a lightsaber blade (100) and the light emitting end (11) of the remaining light source (10) selected from the pair of light sources (10); wherein the inverse coupler (160) further comprises a ring-like cylindrical portion (162), a finger actuation portion (164) disposed over the cylindrical portion (162), and a pair of screw couplings (166) arranged on the opposite sides of the finger actuation portion (164).

16. The modular lightsaber (150) according to claim 14, wherein the light source (10) comprises a handle portion (13), at least one actuation switch (14), a light emitting mechanism (15), and a battery (16).

17. The modular lightsaber (150) according to claim 14, wherein the first connection element (112) and the second connection element (122) comprise a plurality of screw threads (113) and a plurality of screw threads (123) respectively.

18. The modular lightsaber (150) according to claim 14, wherein the plurality of screw threads (113) of the first connection element (112) are disposed on the external surface of the first end (110).

19. The modular lightsaber (150) according to claim 14, wherein the plurality of screw threads (123) of the second connection element (122) are disposed on the internal surface of the second end (120).
